(19) United States
(12) Patent Application Publication
(10) Pub. No.: US 2005/0091055 A1
(43) Pub. Date: Apr. 28, 2005

(54) System and a method for accessing and updating information stored in a central location by a remote worker

(76) Inventor: Paul William Shields, Livingston (GB)

Correspondence Address: OLIFF & BERRIDGE, PLC, P.O. BOX 19928, ALEXANDRIA, VA, 22320, US

(21) Appl. No.: 10/501,835

(22) PCT Filed: Oct. 31, 2003
(86) PCT No.: PCT/GB03/04719

(30) Foreign Application Priority Data
Nov. 1, 2002 (GB) 0225504.0

(51) Int. Cl. G10L 13/00

(52) U.S. Cl. 704/260

(57) ABSTRACT

Information such as patient medical notes, criminal/parole/probationary notes and company information is often stored a central location. When workers such as doctors, health visitors, social workers, police, probation officers and salespersons are working remotely from that central location accessing and updating the relevant information is often quite difficult. Thus the present invention provides a system and method for accessing and updating information stored in a central location by a remote worker, said system comprising: a central store for storing information; and a mobile telephone for use by said remote worker to interrogate and update said store. The mobile phone may includes a TTS system and/or ASR system for facilitating the information being accessed and updated.

The present invention relates to a system and a method for accessing and updating information stored in a central location by a remote worker.

Information such as patient medical notes, criminal/parole/probationary notes and company information is often stored in a central location. When workers such as doctors, health visitors, social workers, police, probation officers and salespersons are working remotely from that central location accessing and updating the relevant information is often quite difficult.

At present, when doctors make house calls, the doctor initially will often return to the doctor's surgery or hospital for the medical notes relating to the patient which the doctor is about to visit. Alternatively, in an emergency, the doctor will rely upon his personal knowledge of the patient. After the visit, the doctor ought to update the patient's medical notes. Hitherto, such updating has occurred in a very haphazard fashion. Sometimes, the doctor forgets to update the medical notes. Sometimes, the doctor makes some manuscript comments of the visit or dictates into a tape recorder. Those manuscript notes or dictation is often given to one of the clerical staff at the doctor's surgery who may forget to update the medical notes or introduce errors.

Recently, some doctors have been relying upon notebook computers to retain the patient's notes and make a visit report. However, the doctor must still obtain a copy of the patient's medical notes. In some circumstances the copy on the notebook computer is out of date. Moreover, it has been found that this can lead to difficulties of data protection. Even using the computer to record the visit report, that report must still be uploaded into the central location medical notes and this is not always effected. Finally, using a computer for some surgeries has proved impossible due to the location of the surgery in high crime risk areas.

It can be envisaged that the computer could be provided with a link to the central location medical notes. However, this would require a special data link due to the security required and the link is prohibitively expensive.

When the information concerns criminal/parole/probationary notes, workers such as probationary officers or the police have to radio or call colleagues who can then interrogate the records of a suspect or criminal. Updating of that information is even more haphazard and the police records as a consequence are notoriously inaccurate.

Finally, when the information concerns companies, sales persons have to phone their colleagues in order to obtain accurate up to date information such as whether the company has paid their last bills or what was the detail of the last order etc.

The present invention thus seeks to overcome these disadvantages.

The present invention provides a system for accessing and updating information stored in a central location by a remote worker, said system comprising: a central store for storing information; and a mobile telephone for use by said remote worker to interrogate and update said store.

The present invention also provides a method of accessing and updating information stored in a central location by a remote worker using a mobile telephone; said method comprises interrogating said central store using said mobile telephone; receiving said information by said mobile telephone; and updating said information stored in said central store using said mobile telephone.

Embodiments of the present invention will now be described by way of further example only and with reference to the accompanying drawings, in which:

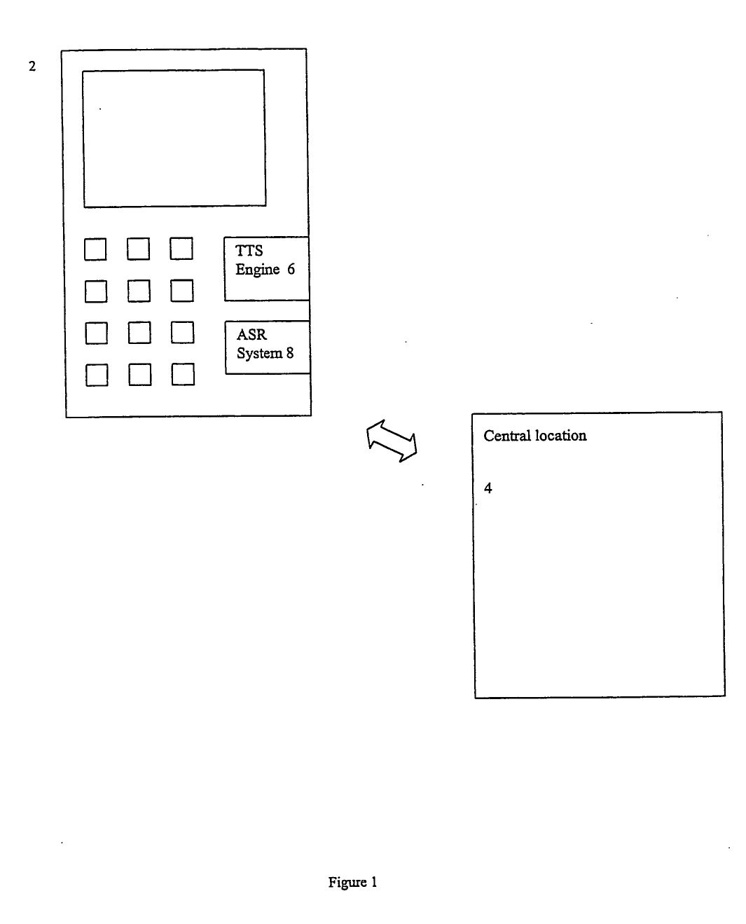

FIG. 1 is a schematic diagram of the system and method of the present invention; and

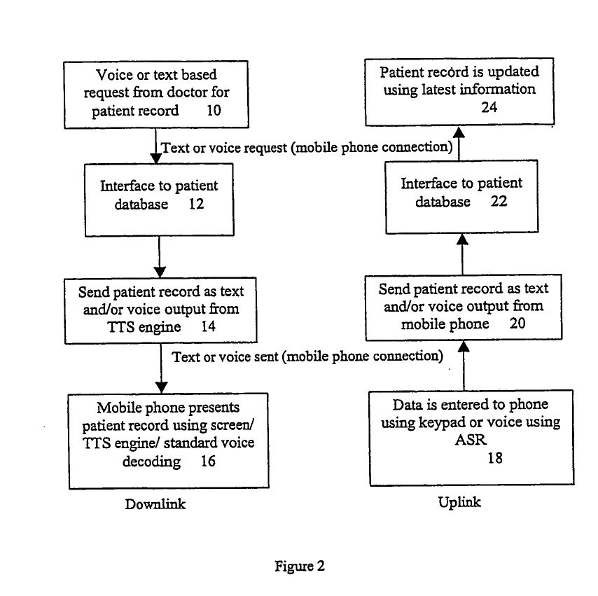

FIG. 2 is a flow diagram of information being accessed and updated.

FIG. 1 illustrates a mobile telephone 2 and a central location 4 for storing information. A remote worker uses the mobile telephone 2 to access and update the information stored in the central location 4. In the case of the information comprising medical notes, there is no need for the doctor to go to the doctor's surgery first. Moreover, in the case of an emergency, the doctor can still obtain the patient's notes and thereby improve the quality of the emergency treatment being given. Following any visit, the doctor can update the medical notes. This is particularly advantageous when the patient is being transferred for further treatment and the subsequent medical practitioners can obtain not only the patient's up to date medical notes but also notes regarding the doctor's emergency visit.

A data encryption method such Pretty Good Protection (PGP) can be implemented to ensure that confidential data is not intercepted by anyone other than the intended recipient. Further details of PGP can be found in “The official PGP user's guide”, by Zimmerman, P R, Barlow J P (1995) The MIT Press (ISBN:0262741076). Such encryption methods are widely used, especially on the Internet.

The present invention also encompasses another embodiment in which the mobile phone incorporates a text to speech (TTS) system 6. In this situation, when the remote worker accesses the information, this can be output aurally.

In either embodiment, the mobile phone could also include an automatic speech recognition (ASR) system 8. In this case, the mobile phone could be controlled on the basis of speech output by the doctor.

FIG. 2 is a flow diagram illustrating the access and updating of the information. In step 10, the doctor enters a voice or text based request for the patient's record. The mobile phone 2 initiates a phone connection to the central location 4. Step 12 provides the interface to the central location and includes security checks. Step 12 also includes receiving details of the particular patient whose medical notes are to be accessed.

Step 14 relates to the access of the patient's record from the central location 4 to the mobile phone 2. Step 14 also includes preparing the patient's record for text or voice output. Finally, step 16 refers to the output of the patient's record using the screen or the TTS system.

FIG. 2 also includes the uploading of information following a patient visit. In step 18, the doctor enters the visit report into the mobile phone either using the keypad or using the ASR 8. The mobile phone initiates a phone connection to the central location 4. In step 20, the updated information is sent to the central location. Step 22 provides the interface to the central location and includes security checks. Step 22 also determines which records are to be updated. Finally, step 24 uses that received to update the patient's records.

The present inventions overcomes the disadvantages enumerated previously by enabling a remote worker such as a doctor to always be able to access the most up to date information and to update that information following a visit. This results in reduced time in attending to such visits. This also results in higher quality treatment being provided and reducing the risk of inaccurate data influencing the treatment.

The aforegoing description has been given by way of example only and it will be appreciated by a person skilled in the art that modifications can be made without departing from the scope of the present invention.

1. A system for accessing and updating information stored in a central location by a remote worker, said system comprising:
a central store for information; and
a mobile telephone for use by said remote worker to interrogate and update said store and in which said mobile telephone includes a Text To Speech (TTS) system for enabling said information to be output aurally.

2. A system as claimed in claim 1, in which said mobile telephone includes an automatic speech recognition (ASR) system for enabling said remote worker to interrogate said store aurally.

3. A system as claimed in claim 1, in which said information is subject to data encryption.

4. A system as claimed in claim 1, in which said information concerns medical information and said remote worker is a medical practitioner.

5. A method of accessing and updating information stored in a central location by a remote worker using a mobile telephone; said method comprises
interrogating said central store using said mobile telephone;
receiving said information by said mobile telephone; and
updating said information stored in said central store using said mobile telephone.

6. A method as claimed in claim 5, in which said mobile telephone includes a Text To Speech (TTS) system for enabling said information to be output by said TTS system.

7. A method as claimed in claim 5, in which said mobile telephone includes an automatic speech recognition (ASR) system for enabling said remote worker to interrogate said store aurally.

8. A method as claimed in claim 5, further comprising encrypting said information before accessing and updating.

9. A method as claimed in claim 5, in which said information concerns medical information and said remote worker is a medical practitioner.

10. A system as claimed in claim 2, in which said information is subject to data encryption.

11. A system as claimed in claim 2, in which said information concerns medical information and said remote worker is a medical practitioner.

12. A system as claimed in claim 3, in which said information concerns medical information and said remote worker is a medical practitioner.

13. A method as claimed in claim 6, in which said mobile telephone includes an automatic speech recognition (ASR) system for enabling said remote worker to interrogate said store aurally.

14. A method as claimed in claim 6, further comprising encrypting said information before accessing and updating.

15. A method as claimed in claim 7, further comprising encrypting said information before accessing and updating.

16. A method as claimed in claim 6, in which said information concerns medical information and said remote worker is a medical practitioner.

17. A method as claimed in claim 7, in which said information concerns medical information and said remote worker is a medical practitioner.

18. A method as claimed in claim 8, in which said information concerns medical information and said remote worker is a medical practitioner.
